(19) United States
(12) Patent Application Publication
(10) Pub. No.: US 2022/0229323 A1
(43) Pub. Date: Jul. 21, 2022

(54) DISPLAY MODULE AND ELECTRONIC DEVICE

(71) Applicant: VIVO MOBILE COMMUNICATION CO., LTD., Dongguan (CN)

(72) Inventors: Huaxin LIN, Dongguan (CN); Chuanbo CHENG, Dongguan (CN)

(73) Assignee: VIVO MOBILE COMMUNICATION CO., LTD., Dongguan (CN)

(21) Appl. No.: 17/715,941

(22) Filed: Apr. 7, 2022

Related U.S. Application Data
(63) Continuation of application No. PCT/CN2020/115391, filed on Sep. 15, 2020.

(30) Foreign Application Priority Data
Oct. 8, 2019 (CN) 201910950355.X

(51) Int. Cl. G02F 1/1339; G02F 1/1333; G02F 1/1335

(52) U.S. Cl. CPC G02F 1/13394; G02F 1/133302; G02F 1/133512; G02F 1/133331

(57) ABSTRACT

A display module and an electronic device are provided. The display module includes: a light-transmissive cover plate, a first substrate, a second substrate, and a first support column. The second substrate is located between the first substrate and the light-transmissive cover plate, and the second substrate has a first region and a second region. The second region is a region, corresponding to a field-of-view range of an optical component, on the second substrate. The first region is located in the second region, and the first region is a region, corresponding to a photosensitive region of the optical component, on the second substrate. The first support column is disposed between the first substrate and the second substrate. At least a part of the first support column is located in a third region. The third region is a region other than the first region in the second region.

### CROSS REFERENCE TO RELATED APPLICATIONS

This application is a continuation of International Application No. PCT/CN2020/115391, filed on Sep. 15, 2020, which claims priority to Chinese Patent Application No. 201910950355.X, filed on Oct. 8, 2019. The entire contents of each of the above-identified applications are expressly incorporated herein by reference.

### TECHNICAL FIELD

The present disclosure relates to the field of display technologies, and in particular to a display module and an electronic device.

### BACKGROUND

With the progress of technologies and the development of electronic devices, users have greater demand for full-screen electronic devices. Therefore, a full screen has gradually become a development trend. Installation positions of cameras, sensors, telephone receivers, and other components are main factors that restrict the development of the full screen. Taking a camera as an example, an existing solution is as follows: a driving mechanism is disposed in a housing of an electronic device, and the driving mechanism is connected to the camera to drive the camera to enter and exit the housing of the electronic device. However, in this way, the demand for the driving mechanism leads to large internal space occupied by the driving mechanism in the housing of the electronic device.

To solve the problem, a light-transmissive hole may be disposed on a display module of the electronic device, and the camera may be disposed towards the light-transmissive hole, to achieve camera functions. The display module includes a first substrate, a second substrate, and a plurality of support columns disposed between the first substrate and the second substrate. The support columns are distributed in a region outside the light-transmissive hole. Such structure occupies less space in the housing of the electronic device and a large screen-to-body ratio of the electronic device approaches the concept of a full screen.

However, in order not to affect light transmittance of the light-transmissive hole, no support column is disposed in the light-transmissive hole, which leads to a weak support force at the light-transmissive hole and easily causes a recess at the light-transmissive hole, affecting the optical performance of the light-transmissive hole and further reducing the performance of the electronic device.

### SUMMARY

The present disclosure provides a display module and an electronic device to solve the problem of low performance of the electronic device.

To solve the foregoing problem, the following technical solutions are used in the present disclosure.

A display module is provided, where the display module is applied to an electronic device with an optical component, and the display module is provided with a light-transmissive hole, where the light-transmissive hole is disposed opposite to the optical component, and the display module includes a light-transmissive cover plate, a first substrate, a second substrate, and a first support column, where

the second substrate is located between the first substrate and the light-transmissive cover plate, and the second substrate has a first region and a second region, where the second region is a region, corresponding to a field-of-view range of the optical component, on the second substrate, the first region is located in the second region, and the first region is a region, corresponding to a photosensitive region of the optical component, on the second substrate; and

the first support column is disposed between the first substrate and the second substrate, and at least a part of the first support column is located in a third region, where the third region is a region other than the first region in the second region.

An electronic device is provided, including the display module.

The technical solutions used in the present disclosure can achieve the following beneficial effects:

In the display module disclosed by the present disclosure, the second substrate has a first region, a second region, and a third region, where the first region is located in the second region, the second region is a region, corresponding to a field-of-view range of an optical component, on the second substrate, the first region is a region, corresponding to a photosensitive region of the optical component, on the second substrate, the third region is a region other than the first region in the second region, and at least a part of a first support column is located in the third region. In this solution, the first support column is disposed in a region covered by the light-transmissive hole. In addition, the first support column may avoid the photosensitive region, so that the structure may help to enhance a support force of a light-transmissive hole without affecting light transmittance of the light-transmissive hole, effectively preventing a recess at the light-transmissive hole. Therefore, the light-transmissive hole has better optical performance, further improving the performance of the electronic device.

### BRIEF DESCRIPTION OF DRAWINGS

The accompanying drawings described herein are used to provide further understanding of the present disclosure and constitute a part of the present disclosure. The illustrative embodiments of the present disclosure and descriptions thereof are used to explain the present disclosure, and do not constitute any improper limitation on the present disclosure. In the accompanying drawings:

FIG. 1 is a partial sectional view of a display module according to an embodiment of the present disclosure; and

FIG. 2 is a top view of the display module according to an embodiment of the present disclosure.

### REFERENCE SIGNS

A—Region of a light-transmissive hole, B—First region, C—Second region, D—First sub-region, E—Second sub-region, F—Third sub-region, G—Fourth sub-region, 100—First substrate, 200—Second substrate, 300—First support column, and 400—Annular light-shielding part.

### DETAILED DESCRIPTION

To make the objectives, technical solutions, and advantages of the present disclosure clearer, the following clearly and describes the technical solutions of the present disclosure with reference to the specific embodiments of the present disclosure and the corresponding accompanying drawings. Apparently, the described embodiments are merely a part rather than all of the embodiments of the present disclosure. All other embodiments obtained by a person of ordinary skill in the art based on the embodiments of the present disclosure without creative efforts shall fall within the protection scope of the present disclosure.

The technical solutions disclosed by various embodiments of the present disclosure are described in detail below with reference to the accompanying drawings.

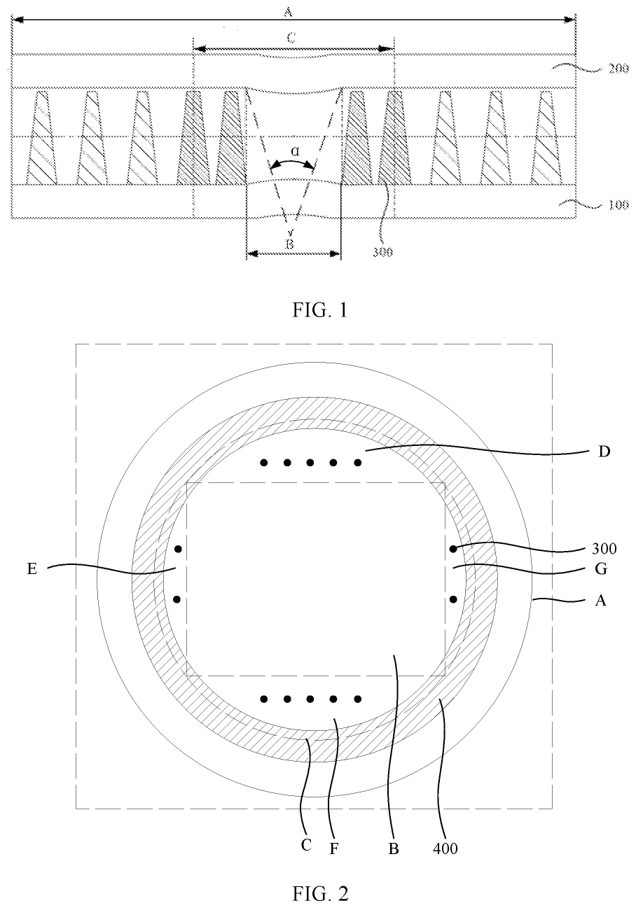

As shown in FIG. 1 and FIG. 2, embodiments of the present disclosure provides a display module which is applied to an electronic device with an optical component. The display module has a light-transmissive hole. The light-transmissive hole has a corresponding light-transmissive hole region A, and the light-transmissive hole is disposed opposite to the optical component. In some embodiments, the optical component includes at least one of a camera and a flash light.

The display module may specifically include a light-transmissive cover plate, a first substrate 100, a second substrate 200, and a first support column 300. The second substrate 200 is located between the first substrate 100 and a light-transmissive cover plate. The second substrate 200 has a first region B and a second region C. The second region C is a region, corresponding to a field-of-view range (a range corresponding to an angle α as shown in FIG. 1) of the optical component, on the second substrate 200. The first region B is located in the second region C. The first region B is a region, corresponding to a photosensitive region of the optical component, on the second substrate 200. Specifically, main bodies of the first substrate 100 and the second substrate 200 are glass plates, the second substrate 200 is provided with components such as an optical filter, the second substrate 200 and the light-transmissive cover plate are bonded by an optical adhesive, and the first substrate 100 is provided with components such as a thin film transistor. When the display module is a liquid crystal display module, liquid crystal is filled between the first substrate 100 and the second substrate 200. In this case, the electronic device is provided with a backlight module. The backlight module is further provided with a through hole at a position corresponding to the light-transmissive hole. In this case, the optical component is installed under the display module, which will not occupy too much display region. Therefore, the electronic device has a larger screen-to-body ratio.

The first support column 300 is disposed between the first substrate 100 and the second substrate 200. At least a part of the first support column 300 is located in a third region. The third region is a region in the second region C other than the first region B.

According to this embodiment of the present disclosure, the first support column 300 is disposed in a region covered by the light-transmissive hole. In addition, the first support column 300 may avoid a photosensitive region, so that the structure may help to enhance a support force of the light-transmissive hole without affecting light transmittance of the light-transmissive hole, effectively preventing a recess at the light-transmissive hole. Therefore, the light-transmissive hole has better optical performance, further improving the performance of the electronic device.

Because there is an installation allowance during installation of the optical component, the first region B may be actually slightly larger than the field-of-view range of the optical component, so as to prevent vignetting when the optical component is installed. Light beyond the field-of-view range of the optical component may be shielded by silk screen on the optical filter.

In one embodiment, there is a plurality of the first support columns 300. The plurality of the first support columns 300 is disposed at intervals. In this solution, the support force of the light-transmissive hole is further enhanced, further improving the optical performance of the light-transmissive hole.

Specifically, one end of the first support column 300 is fixedly connected to the first substrate 100, and the other end of the first support column 300 may be connected to the second substrate 200. In this solution, the first support column 300 is in contact with both the first substrate 100 and the second substrate 200, so that the first support column 300 strongly supports the first substrate 100 and the second substrate 200. Therefore, a support force of the light-transmissive hole becomes stronger, and then the light-transmissive hole has better optical performance.

However, when the display module in the foregoing embodiment bears an external force, because the first support column 300 is in contact with both the first substrate 100 and the second substrate 200, the first substrate 100 and the second substrate 200 has large stresses, which easily causes the display module to be damaged, thus affecting the light transmission performance of the light-transmissive hole. To solve this problem, in one embodiment, one end of the first support column 300 is fixedly connected to the first substrate 100, and there is a gap between the other end of the first support column 300 and the second substrate 200. In this case, when the second substrate 200 is forced to bend, the gap can play a buffering role, so that the stresses of the first substrate 100 and the second substrate 200 become small, and the display module is not easily damaged. In some embodiments, the gap between the first support column 300 and the second substrate 200 may further be filled with a buffer material. In this case, the buffer material may provide a support force for the second substrate 200. In addition, when the second substrate 200 is deformed by a pressure, the buffer material may further be elastically deformed, which can play a buffering role, thus further improving the reliability of the display module.

To enable both a strong support force and a good buffering force to be provided between first substrate 100 and the second substrate 200, in one embodiment, there is a plurality of the first support columns 300, and the plurality of the first support columns 300 are displayed at intervals. One part of the first support columns 300 is in contact with both the first substrate 100 and the second substrate 200. One end of the other part of the first support column 300 is fixedly connected to the first substrate 100, and there is a gap between the other end and the second substrate 200. In this case, a strong support function and a good buffering function both provided between the first substrate 100 and the second substrate 200 further improves the performance of the display module.

In one embodiment, the second region C is a circular region, the first region B is a rectangular region, and the first region B is tangent to the second region C. Because a photosensitive region of a photosensitive chip in the foregoing optical component is rectangular, this solution can enable the second region C to be adapted to the photosensitive region as much as possible, thus better utilizing light and preventing stray light from entering the light-transmissive hole. Specifically, the photosensitive chip may be a complementary metal oxide semiconductor (Complementary Metal Oxide Semiconductor, CMOS) imaging chip with a 4:3 rectangular structure.

Because the first region B is tangent to the second region C, the third region is divided into a plurality of sub-regions. Specifically, the third region includes a first sub-region D, a second sub-region E, a third sub-region F, and a fourth sub-region G. In addition, the first sub-region D, the second sub-region E, the third sub-region F, and the fourth sub-region G are arranged around the first region B. An area of the first sub-region D is the same as that of the third sub-region F, and an area of the second sub-region E is the same as that of the fourth sub-region G. In order to average support forces among the sub-regions, the number of the first support columns 300 in the first sub-region D and the third sub-region F is greater than the number of the first support columns 300 in the second sub-region E and the fourth sub-region G. In this solution, as the first sub-region D and the third sub-region F have large areas, there are a great number of the first support columns 300. As the second sub-region E and the fourth sub-region G have small areas, there are a small number of the first support columns 300. In this case, support forces born by all sub-regions are relatively uniform, so the optical performance of the light-transmissive hole is better.

In one embodiment, the number of the first support columns 300 in the first sub-region D is equal to the number of the first support columns 300 in the third sub-region F, and the number of the first support columns 300 in the second sub-region E is equal to the number of the first support columns 300 in the fourth sub-region G. In this solution, the numbers of the first support columns in symmetrical regions are the same, so that support forces born by symmetrical sub-regions are the same, thereby enabling support forces born by all sub-regions are more uniform, furthering leading to a stronger support force for the light-transmissive hole.

In one embodiment, to prevent an edge region of the light-transmissive hole from leaking light, which affects the performance of the optical component, an annular light-shielding part 400 is further disposed in the light-transmissive hole. A center of the circle of the annular light-shielding part 400 coincides with a center of the circle the second region C. In this case, the annular light-shielding part 400 can cover the edge region of the light-transmissive hole, preventing stray light from entering the optical component. In addition, the center of the circle of the annular light-shielding part 400 coincides with the center of the circle of the second region C, so that when a light beam enters a photosensitive region, the light beam will not be blocked by the annular light-shielding part 400. Therefore, the optical component can receive more light beams, further improving the performance of the optical component.

In one embodiment, the display module further includes a second support column. The second column is located between the first substrate 100 and the second substrate 200, and an annular light-shielding part 400 is disposed in the light-transmissive hole, and one end of the second support column is connected to the annular light-shielding part 400. In this solution, a second support column is disposed in a region covered by the annular light-shielding part 400, so that a support force at the annular light-shielding part 400 can be improved. Therefore, a support force of the light-transmissive hole is further enhanced, and the whole light-transmissive hole is not easy to sag, so that the light-transmissive hole has better optical performance.

Specifically, the first support column 300 has a relatively strong support force but generates a relatively strong stress, and the second support column has a relatively weak support force but can alleviate a stress generated by the first support column 300.

In some embodiments, the number of the first support columns 300 is greater than that of second support columns, and the second support columns are evenly distributed among the first support columns 300, so that a support force at the light-transmissive hole is relatively uniform and no great stress is generated.

Based on the display module described in any of the foregoing embodiments of the present disclosure, an embodiment of the present disclosure further discloses an electronic device. The disclosed electronic device has the display module and the optical component described in the embodiments. The display module has a light-transmissive hole, and the light-transmissive hole is disposed opposite to the optical component. In this case, the optical component is directly installed under the display module, which will not occupy too much display region. Therefore, the electronic device has a larger screen-to-body ratio.

The electronic device disclosed in the embodiments of the present disclosure may be a smartphone, a tablet computer, an e-book reader, or a wearable device. Certainly, the electronic device may also be another device, which is not limited in the embodiments of the present disclosure.

The embodiments of the present disclosure focus on describing differences between the embodiments, and different optimization features of the embodiments may be combined to form better embodiments provided that they are not contradictory. Considering brevity, details are not described herein again.

The foregoing descriptions are merely embodiments of the present disclosure, but are not intended to limit the present disclosure. Various changes and modifications may be made to the present disclosure by those skilled in the art. Any modifications, equivalent substitutions, improvements, and the like made within the spirit and principle of the present disclosure should be included within the scope of the claims of the present disclosure.

1. A display module of an electronic device having an optical component, the display module comprising:
a light-transmissive hole disposed opposite to the optical component;
a light-transmissive cover plate;
a first substrate;
a second substrate; and
a first support column,
wherein
the second substrate is located between the first substrate and the light-transmissive cover plate, and the second substrate has a first region and a second region,
the second region is a region corresponding to a field-of-view range of the optical component and on the second substrate,
the first region is located in the second region, and the first region is a region corresponding to a photosensitive region of the optical component and on the second substrate, and
the first support column is disposed between the first substrate and the second substrate, at least a part of the first support column is located in a third region, and the third region is a region other than the first region in the second region.

2. The display module according to claim 1, further comprising:
a plurality of the first support columns, wherein the plurality of first support columns are disposed at intervals.

3. The display module according to claim 1, wherein one end of the first support column is fixedly connected to the first substrate, and the other end of the first support column is in contact with the second substrate.

4. The display module according to claim 1, wherein one end of the first support column is fixedly connected to the first substrate, and a gap is located between the other end of the first support column and the second substrate.

5. The display module according to claim 1, wherein the second region is a circular region, the first region is a rectangular region, and the first region is tangent to the second region.

6. The display module according to claim 5, wherein the third region comprises a first sub-region, a second sub-region, a third sub-region, and a fourth sub-region, wherein the first sub-region, the second sub-region, the third sub-region, and the fourth sub-region are arranged around the first region, an area of the first sub-region is the same as that of the third sub-region, an area of the second sub-region is the same as that of the fourth sub-region, and the number of the first support columns disposed in the first sub-region and the third sub-region is greater than the number of the first support columns disposed in the second sub-region and the fourth sub-region.

7. The display module according to claim 6, wherein the number of the first support columns disposed in the first sub-region is equal to the number of the first support columns disposed in the third sub-region, and the number of the first support columns disposed in the second sub-region is equal to the number of the first support columns disposed in the fourth sub-region.

8. The display module according to claim 1, further comprising:
a second support column located between the first substrate and the second substrate; and
an annular light-shielding part disposed in the light-transmissive hole, wherein one end of the second support column is connected to the annular light-shielding part.

9. The display module according to claim 1, further comprising:
an annular light-shielding part disposed in the light-transmissive hole, wherein a center of circle of the annular light-shielding part coincides with that of the second region.

10. An electronic device, comprising:
a display module; and
an optical component,
wherein the display module comprises:
a light-transmissive hole disposed opposite to the optical component;
a light-transmissive cover plate;
a first substrate;
a second substrate; and
a first support column,
wherein
the second substrate is located between the first substrate and the light-transmissive cover plate, the second substrate has a first region and a second region,
the second region is a region corresponding to a field-of-view range of the optical component and on the second substrate,
the first region is located in the second region, and the first region is a region corresponding to a photosensitive region of the optical component and on the second substrate, and
the first support column is disposed between the first substrate and the second substrate, at least a part of the first support column is located in a third region, and the third region is a region other than the first region in the second region.

11. The electronic device according to claim 10, wherein the optical component comprises at least one of a camera and a flash light.
